(19) United States
(12) Patent Application Publication
(10) Pub. No.: US 2018/0018428 A1
(43) Pub. Date: Jan. 18, 2018

(54) SYSTEM, APPARATUS AND METHOD FOR DISPLAYING ELECTRONIC HEALTH CARE RECORDS

(71) Applicant: Robert E. COIFMAN, Millville, NJ (US)

(72) Inventor: Robert E. COIFMAN, Millville, NJ (US)

(21) Appl. No.: 15/473,584

(22) Filed: Mar. 29, 2017

Related U.S. Application Data
(60) Provisional application No. 62/390,437, filed on Mar. 29, 2016.

(51) Int. Cl. G06F 19/00; G06F 17/30

(52) U.S. Cl. CPC G06F 19/322; G06F 17/30283

(57) ABSTRACT

An improved computer-based system displays multiple sets of standard data in which a first set of standard data does not typically include data elements from other sets of standard data. A display processor drives the computer display and runs a display program having a standards module, a records module, and a mapping module. A standards database contains information related to the standard at issue and a records database contains the sets of standard data to be displayed. Both databases are accessed by the display program in creating a virtual field within the display of the first set of standard data. The mapping module selects appropriate data elements from the other set of standard data for display within the virtual field. Display flags may be provided to indicate critical virtual data. The primary use of the invention is in the display of electronic health records within an examination room setting.

### CROSS-REFERENCE TO RELATED APPLICATIONS

This application is a non-provisional U.S. patent application that claims priority to U.S. Provisional Patent Applications, Ser. No. 62/390,437, titled “Apparatus and Method for Providing an Improved Electronic Health Record System,” filed on Mar. 29, 2016. The entire contents of that provisional patent application is incorporated by reference as if set forth herein in their entirety into the present patent application.

### BACKGROUND OF THE INVENTION

### 1. Field of the Invention

The invention relates to health care management in general, and more specifically, the display of electronic health records (EHRs). Apparatus, methods and systems for coordinating the composite display of multiple sets of standard medical information within a single display are disclosed, all in the context of the patient exam room environment for ease of use by the attending medical personnel.

### 2. Description of Related Art

As background, the present invention involves a series of software modules operating as a part of a software platform associated with a computer-based medical system. The medical system is optimized to display electronic health care records (EHRs) in an efficient, user-friendly format. The software modules may be plugin software module(s), provided as an add-on to an existing EHR records system, or they may function as an integral part of a larger, standard EHR software package used by health care professionals within a medical office. Ideally, the software modules are part of an open software platform that is easily coded to by other programmers through application program interfaces (APIs). The plug-in software modules are coded to operate on patient medical data. The target medical data may be provided in any of a number of formats (proprietary or standard) or may be derived from any of a number of sources (public or private).

The above apparatus, methods and systems are used to convert medical EHR data, displayed in a first format and containing a first set of standard data, to a second display format, that includes the first set of standard data as well as relevant portions of a second set of standard data. The formats themselves may also be standard. The incorporation of the additional data from the second set within the first display provides a more efficient and easily reviewed EHR display and interface for the attending health care professional.

Prior art systems are designed to address a host of other problems concerning medical records displays, but not in the manner of the present invention:

Haider et al., U.S. Pat. Appln. Pub. No. 20070282633, published Dec. 6, 2007 discloses a generalized EHR system that extracts and displays medical data from an EHR database containing data from a plurality of patients each having a plurality of health records. A user index and rules data base is provided storing a plurality of health care professional user specific profiles, and also rules for controlling a retrieval engine. A patient index is provided storing patient demographic information along with medical problem codes for a plurality of patients. The retrieval engine is connected with a display. With the retrieval engine, data from the electronic health data base is retrieved for the specific patient and for the specific medical problem according to a specific healthcare professional user profile and according to the medical problem codes stored in the patient index. A behavior of the retrieval engine is controlled by the rules stored in the user index and rules data base. With the display, a chart shows relevant medical information for the specific medical problem of the specific patient Haider et al.'s display chart is presented a so-called cockpit-chart style overview focusing on information relevant for medical diagnosis and further treatment. Haider's “cockpit-chart style” is intended to mean a convenient chart style presentation which allows for a quick overview of the extracted medical information focusing on certain specific information relevant to a certain specific diagnostic question or questions. Overlapping displays of different sets of standard data are neither needed nor discussed in Haider et al.

Stern et al., U.S. Pat. No. 7,624,027, published Nov. 24, 2009 discloses a method and system for automated medical records processing. The method and system includes plural paper and electronic templates specifically designed such that they reduce the complexity of collecting patient encounter information and help generate the appropriate number and type medical codes for a specific type of medical practice when processed. The method and system also includes processing applications that allow easy and automated collection, processing, displaying and recording of medical codes (e.g., diagnosis codes, billing codes, insurance codes, etc.). The medical codes and other types of processed patient encounter information are displayed in real-time on electronic templates immediately after a patient encounter. Real-time displays of one or more electronic templates is provided for by Stern et al., but the displayed data is primarily related to medical code information which codes are the drivers of the entire system of Stern. Overlapping displays of different sets of standard data are neither needed nor discussed in Stern et al.

Molenda, U.S. Pat. Appln. Pub. No. 20150134361 published May 14, 2015 discloses systems and method for generating a record of a medical procedure. Molenda's system includes a processor and a non-transitory computer readable medium. The medium includes a graphical user interface configured to display a graphic representing an anatomical region of a patient and accept a gesture from a user comprising a selected procedure and, diagnosis when appropriate, and a location on the displayed anatomical region. A knowledge base stores a plurality of templates, each comprising a set of fields. A record generation engine selects an associated one of the plurality of templates according to each of the selected procedure and, diagnosis when appropriate, and the location on the displayed anatomical region and populates the set of fields associated with the selected template. A database interface formats the populated template into a database record suitable for an electronic health records database associated with the system. Overlapping displays of different sets of standard data are neither needed nor discussed in Stern et al.

Smith, U.S. Pat. No. 8,265,952, published Sep. 11, 2012 discloses methods and systems for implementing coding changes for a transaction. At least one transaction in an original format is received and normalized into a different format. The normalized transaction may be processed and the processing results may be associated with the original format to transmit the processing results in the original format to a recipient. Although various normalizations, prioritization and reformatting of health care codes are disclosed by Smith, no overlapping displays of different sets of standard data are discussed or disclosed in Smith.

Presently, there are no adaptable display systems that permit the efficient review of a patent's EHR data. Under the 1995 and 1997 evaluation and management (E/M) documentation guidelines for evaluation and management services, standard sets of EHR data are now defined having supersets and subsets of relevant data depending on the patient's particular ailment and attending medical personnel. Further complicating this, coding of a patient encounter as one type of medical code versus another results in different required number of examination points to achieve a certain level of compensable medical treatment. Further, the EHR data sets themselves may contain data that is either spatially and/or temporally separated. This poses a display problem within the context of the limited display areas provided on the computer screens with today's medical environment. The need exists for determining and providing a more uniform, method and apparatus for displaying a patient's relevant EHR data, both temporally and spatially, and within appropriately selected subsets of an entire standard EHR data set. Further, the capability of expanding a displayed set of standard EHR data records within a given display is a desirable intermediate result that would greatly aid the physician's review.

Thus, a need exists in the art for an improved display capability, implemented in medical office operable software, that provides for a more efficient and easily-read visual display interface for presenting patient EHR information.

### BRIEF SUMMARY OF THE INVENTION

In one particularly preferred embodiment, the invention includes a computer-based electronic health records system, a display processor coupled to an associated memory, said display processor coupled to a computer display for displaying a patient's electronic health records, said display processor coupled to a computer-based health care network and running a display program from said associated memory, said display program having a standards module, said standards module accessing a standards database over said health care network, said standards module retrieving from said standards database information regarding a first and second display, said standards module determining a first and second set of data to be displayed within said first and second displays respectively on said computer display based on said retrieved information; a patient records module, said patient records module accessing a patient records data base over said health care network, said patient records module selecting a first set of standard data to be displayed in said first display, said patient records module selecting a second set of standard data to be displayed in said second display, said patient records module retrieving said first and second sets of standard data and storing said first and second sets of standard data in said associated memory, said first and second displays having data fields in which data elements of said respective first and second standard sets of data are displayed; and a mapping module, said mapping module displaying said data elements of said first standard set of standard data within said data fields of said first display, said mapping module creating at least one virtual display field within said first display, said mapping module selecting data elements from said second set of standard data to be displayed within said first display, said mapping module displaying said selected set of second data elements within said virtual fields for composite display with said data elements of said first set of standard data.

In particularly preferred aspects of this embodiment said first and second displays are themselves standard and said data fields of said first standard display correlate with said data elements within said first set of standard data, said display program displaying each data element of said first set of standard data within said corresponding data field of said first standard display; said virtual display fields within said first standard display are customized and specified by a health care professional, said health care professional specifying said set selected set of second data elements to be displayed within said virtual field; said virtual field is one of an expanded field or a drop-down box; said virtual field further includes an alert box, said alert box indicating a critical condition within said selected set of second data elements within said virtual field; said first and second sets of standard data contain EHR data of a medical patient, said EHR data pertaining to one of a body system or a single organ system of said patient; said first and second displays are associated with a first and second physician practice areas respectively, said second set of data elements within said virtual field not being within said first set of standard data; and said first and second sets of standard data contain EHR data of a medical patient, said EHR data pertaining to one of a body system or a single organ system of said patient.

In a particular preferred computer-implemented method of displaying electronic health records using a computer-based health records system, said electronic health records system includes a display processor coupled to an associated memory, said display processor coupled to a computer display, said display processor coupled to a computer-based health care network and running a display program from said associated memory, said display program including a standards module, a patient records module and a mapping module, said method includes the steps of accessing a standards database over said health care network with said a standards module; retrieving from said standards database with said standards module information regarding a first and second display, said standards module; determining with said standards module a first and second set of data to be displayed within said first and second displays respectively on said computer display based on said retrieved information; accessing a patient records data base over said health care network with said patient records module; selecting a first and second set of standard data to be displayed in said first and second display respectively, said first and second displays having data fields in which data elements of said respective first and second standard sets of data are displayed; storing with said patient records module said first and second sets of data in said associated memory; displaying with said mapping module said data elements of said first standard set of data within said data fields of said first display; creating with said mapping module at least one virtual display field within said first display; selecting with said mapping module data elements from said second set of standard data to be displayed within said first display; and displaying with said mapping module said selected set of second data elements within said virtual fields for composite display with said data elements of said first set of standard data. In other preferred aspects the method comprises displaying said virtual field as one of an expanded field or a drop-down box; or displaying an alert box, said alert box indicating a critical condition within said selected set of second data elements within said virtual field.

The objects and features of the present invention may be applied jointly or severally in any combination or sub-combination by those skilled in the art.

### BRIEF DESCRIPTION OF THE SEVERAL VIEWS OF THE DRAWING(S)

The accompanying drawings, which are incorporated in and constitute part of this specification, illustrate embodiments and/or aspects of the invention and/or disclosure, and together with the written description, these drawing serve to explain the principles of the invention. However, it is to be understood that the disclosed embodiments are merely exemplary of the invention(s), which may be embodied in various forms. Therefore, specific structural and functional details disclosed herein are not to be interpreted as limiting, but merely as a basis for the claims and as a representative basis for teaching one skilled in the art to variously employ the present invention(s) in virtually any appropriately detailed structure. Further, the terms and phrases used herein are not intended to be limiting, but rather to provide an understandable description of the invention(s).

Wherever possible, the same reference numbers are used throughout the drawings to refer to the same or like elements of an embodiment. The embodiments illustrated herein are presently preferred, it being understood, however, that the invention is not limited to the precise arrangements and instrumentalities shown, in which:

FIG. 1 shows an exemplary network diagram of a healthcare market and its participants according to one embodiment of the present invention;

FIG. 2 shows an exemplary network diagram of a medical practice group according to one embodiment of the present invention;

FIG. 3 shows a combined hardware-software-network architecture diagram according to one embodiment of the present invention;

FIGS. 4A and 4B show an operational flow chart according to one embodiment of the method of the present invention;

FIGS. 5A and 5B show a display containing display fields of a first standard EHR data set according to the system and method of the present invention;

FIGS. 6A and 6B show a display containing display fields of a second standard EHR data set according to the system and method of the present invention;

FIGS. 7A and 7B show the left and right sides of a dual column display, the display showing display fields and a composite display according in which certain elements of one standard EHR data are displayed along with elements of the second display, according to the system and method of the present invention.

FIGS. 8A and 8B show the left and right sides of another dual column display showing a composite display according in which certain elements of one standard EHR data are displayed along with elements of the second display according to the system and method of the present invention.

FIGS. 9A and 9B shows a breakout display for presenting flagged data within a display according to one aspect of the present invention.

### DETAILED DESCRIPTION OF THE INVENTION

To facilitate a clear understanding of the present invention, illustrative examples are provided herein which describe certain aspects of the invention. However, it is to be appreciated that these illustrations are not meant to limit the scope of the invention, and are provided herein to illustrate certain concepts associated with the invention.

It is also to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random-access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed. Specifically, any of the computers or devices may be interconnected using any existing or later-discovered networking technology and may also all be connected through a lager network system, such as a corporate network, metropolitan network or a global network, such as the internet.

The system, apparatus and methods described below are provided in the particular context of the health care industry and the display of a patient's EHR data. However, the invention of the present application is generally applicable to any other information retrieval and display systems in which standard sets of data are to be displayed. [Another real word example??] Using the teachings of the present invention, those of skill in the art will appreciate the general concept of the presentation of a subset of information from one standard data set within the display of another set of standard data.

Although general examples and descriptions are provided below, it should be appreciated by those of skill in the art that certain nomenclature is interchangeable. Specifically, two types of health care participants are provided in the description below and are distinguished as defined by their interaction with the patients. A health care provider is used below to denote a person or an entity that interacts with the patient and cares directly for the patient's health. Health care providers may include but are not limited to one or more of a: doctor, physician, attending health care provider, nurse, physician's assistant etc. A health care administrator includes but is not limited to a person or entity in the health care industry that administrates the delivery of the health care provided to the patient: e.g. HMOs, PPOs, software and system providers for the health care markets (e.g. EHR systems and software providers), health care claims managers/adjusters, etc. The primary distinction between health care providers and health care administrators is that the health care provider directly attends to the caring for the patient and directly provides the patient health care services and counseling. Health care administrators, by contrast, are involved in any of the myriad, ministerial aspects of processing the actual health care provide to the patient.

The Healthcare Information Landscape

The healthcare landscape has always been complicated but not always as complex as it is presently. Historically, health care documentation was a paper-centered, human resource driven system. In every aspect of the medical practice, paper constituted all the documents from which the health care professionals and administrators worked. Patient records, medical coding forms, health care claims forms, billing, follow-up visit notices, all were administrated through the management of paper. These paper forms documented every aspect of the practice of medicine, from the doctor-patient encounter in arriving at and documenting a diagnosis, to the medical coding needed to pay patient health care claims. From the doctor-patient perspective, paper provided a convenient recording medium: it was easy manage, and it could be easily shared as between the doctor and patient it was easily stored. In this regard, the doctors and other health care providers had a certain degree of latitude and autonomy as to which forms they could use in the practice of medicine. Within the examining room, doctors could use certain “standard forms” to document the doctor-patient encounter, where the “standard form” was provided by one or more health care administrators. Alternatively, or in combination, doctors could use their own “custom forms” designed by themselves so as to provide a more familiar data environment tailored to that particular doctor's practice area, practice methodology, personal preferences, etc.

With respect to a doctor's custom forms, the paper method of recordkeeping permitted doctors to design a form that suited their particular practice. Form fields could be located anywhere on the form pages and were capable of containing any relevant information that the doctor deemed necessary to properly practice their specialty area in the manner they desired. Of course, ultimately, the doctor's timely compensation was directly dependent on the proper completion of “standard forms” use by or required by the health care administrators and the billing entities involved in the health care claim management process. A doctor's custom forms would often need re-recoding or transcription into the “standard” or “required” forms used to effect payment. This, in turn, would typically require a doctor's office personnel to spend time and effort to redraft the doctor's encounter information into the “standard” or “required” paper forms.

In this manner, health care providers historically drove the information generation process since they were responsible for generating and recording data particular to the doctor-patient encounter. Over time, health care administrators came to demand that the data so recorded be provided in certain formats for ease of administration. Regardless of the process and information drivers, both groups alike had to deal with the flipping of paper pages to find relevant information, as it pertained either to a patent encounter and a diagnosis or as to the administration of the health care practice.

The advent of computer-based health care systems and associated record-keeping incontrovertibly changed all that. Patient encounters are documented now with the most meticulous exactitude. Further, the record keeping is primarily driven by the health care administrators and not the providers. Analogous to paper, the associated record keeping and billing are equally driven by the complete and proper completion of computer-based forms and the population of computerized display form fields. In this transition, the health care providers lost their data display and recordation autonomy. Increasing regulation by government and the health care insurance companies, including every billing, auditing, data collection and information management entity that work with them, resulted in the data collection driving the health care provision itself.

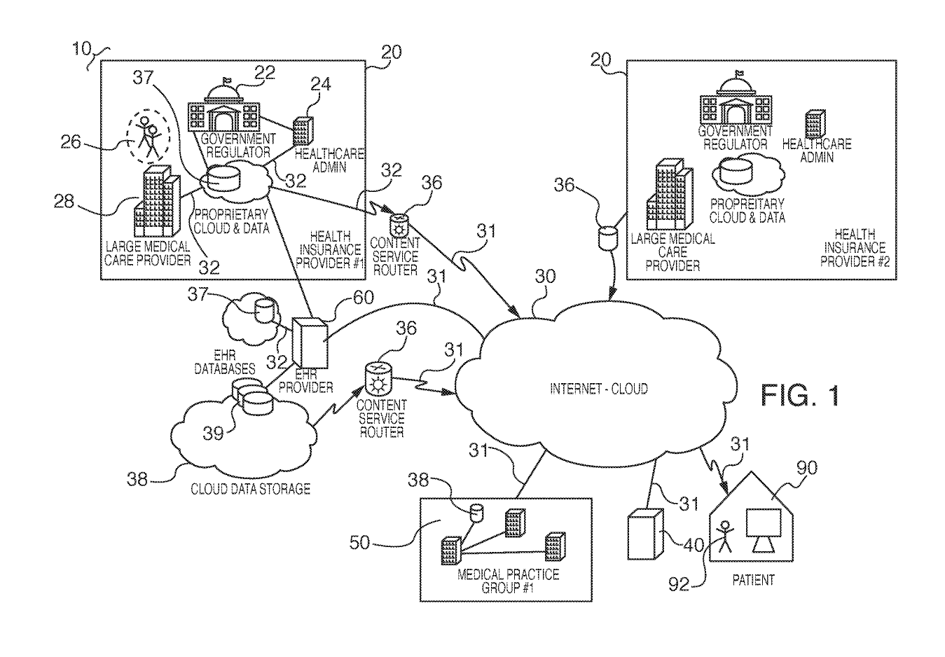

FIG. 1 provides a high-level overview of the health care industry 10 from an organizational and information perspective. Health insurers 20 are organized as large corporate entities containing numerous industry participants. Government regulators 22 provide regulations and guidance as to how the health care insurer operates. Health insurance companies have physical administrative facilities 24 in which many of the administrative functions of the health care insurers take place. Health insurers may employ and be tightly associated with large networks of health care providers 26. The associated health care providers may be tightly coupled such that many providers work within one or more large health care facilities 28, or they may be more loosely coupled as described with respect to the individual doctor practices described below.

With respect to interconnectivity, the health care insurer is connected to each of the other entities with which it works through one or more external, public computer networks 31 and internets 30. Each of the computer network and internets are in turn connected to one another such that they are all interconnected. The internet or network interconnectivity to each of the health care industry participants may be through routers 36. Routers 36 may also interconnect various private or proprietary internal sub-networks 32 operated within the health insurer or other industry participant as proprietary internal computer networks. Other third-party health care administrators such as EHR providers 60, claims managers, electronic health record providers etc. may also be coupled to each other and to the other health care industry participants through the internet 30 and public networks 31 or through dedicated private networks 32.

Cloud-based data storage 38 containing patient EHRs 39 may be coupled to the internet 30 and other public networks 31. Cloud-based storage may exist on corporate commercial data platforms such as those provided by Amazon, Google or Microsoft. Proprietary and/or private cloud-based storage platforms may also be included within the overall network in that they may be housed and controlled by the individual health care market participants. For example, EHR provider 60 may operate its own private networks and internet 32 on which EHR data is privately held within databases 37. Similarly, health care insurers may create, own and/or operate similar private networks and cloud-based data storage for storage of patent data including EHRs.

Access to each of the databases in FIG. 1 containing EHR data is provided over one or more of the public 31 or private 32 computer networks and the internet 30. Data security software, protocols, access permissions etc. are constructed and operated by each of the entities responsible for maintaining that data storage. Individual health care participants may implement their own data security initiatives or may contract those functions out to third party providers of such services. Further, government regulator 22 may also implement policies that govern any particular industry participant's access to patient EHR data. As such, the laws and regulations promulgated by Government regulator 22 may be implemented within the access and security mechanisms provided as part of any of the overall data access paradigm imposed upon one or more portion of the overall health care system.

Individual health care providers 40, including groups thereof 50, may include single dwelling health care service centers, or clusters of the same, occupied by one or more health care providers. Patients 92 may visit these health care providers or have service calls made on their behalf as part of rendering of health care within the system. As with the health care administrators, patients and doctor's offices are all connected through public 31 or private 32 computer networks and the internet 30 to one another and to the other health care industry participants.

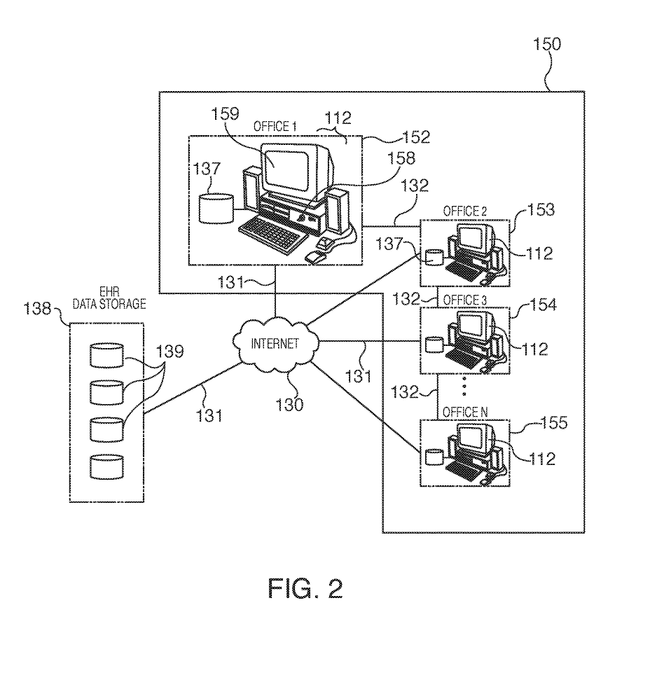

Referring to FIG. 2, a medical practice group 150 is shown having a number of individual offices 152-155. Each office is connected to itself and to the internet 130 through the aforementioned public 131 and private 132 computer networks. Cloud data storage 138 containing EHR databases 139 is also provided and made accessible to each of the computer systems 112 within the doctor's offices via the internet 130. Finally, each of the computer systems 112 may contain its own data storage 137, its own central processing unit 158 with associated memory and a display 159.

FIGS. 1 & 2 set forth a somewhat generic computer architecture associated with any information-based industry. Numerous articles and reports have been written as to why a more standard enterprise-level architecture has not been defined and used within the health care industry. See “Where is Enterprise Architecture in Healthcare?” InformationWeek Nov. 20, 2013; and “A Health IT Framework for Accountable Care,” CCHIT ACO HIT Framework (2013). These articles postulate that the problem is stated as one of data driven results where the concepts of integration, interoperability data quality process automation and analytics are simple to describe but difficult to execute. It is speculated that the lack of more defined physical structures leads to a preoccupation with data management as a means of ensuring health care quality and EMRs in particular as a necessary precursor to a more cost-effective data-driven healthcare system. As a consequence, accountable care organizations (ACOs), numbering in the hundreds and thousands, have arisen to self-police the provision of health care. According to the Centers for Medicare and Medicaid (CMS), an ACO is “an organization of health care practitioners that agrees to be accountable for the quality, cost, and overall care of Medicare beneficiaries who are enrolled in the traditional fee-for-service program who are assigned to it.” In fact, a now defunct not-for-profit organization, the Certification Commission for Health Information (CCHIT), issued a 42-page report on a Health IT framework for Accountable Care. Numerous high level charts of key processes and functions are provided as guideposts to meet the aims of ACOS, but nowhere in the report is there any mention of enterprise IT level solutions to the development of affordable and accountable care. To compensate yet still achieve their goals, the ACOS, in turn, have resorted to external service and technology partners, such as EHR service and system providers, to implement their ACO responsibilities. However, the addition of more health care administrative entities (and consequently people), the grater the burden on the healthcare system without clinical benefit. As additional data collection, monitoring and evaluation organizations are generated, the farther the health care industry strays from the clinical goals of; 1) improving health car outcomes; 2) controlling health care costs; 3) focused risk mitigation; 4) managing security; and 5) ensuring quality and consistence in a forward moving industry path. Thus, a return to focus on the doctor-patient encounter is the key to returning the health care system to a more efficient and patient-driven mode of operation.

Given the volumes of health care data that's being generated, attending physicians are overwhelmed by the administrative needs to collect and present the data without any concomitant benefit to the healthcare rendered to the patient. Unique industry participants are, of course, present to “assist” with this task. For example, EHR companies 60 that have made a business of managing medical data have interposed themselves as data manager between the health insurance companies and the health care provider. In order to process claims made with any of the health care insurance companies, health care providers must comply with the substance (and often the form) of data collection specified by the EHR. To some medical health providers, this is inefficient and unhelpful at best, and to others, an anathema to the practice of medicine in any well-functioning health care system.

### Standardized EHR

In 1995, the American Medical Association's Editorial Board released its Current Procedural Terminology (CPT) guidelines entitled the “1995 Documentation Guidelines for Evaluation and Management Services” (hereinafter the “1995 Guidelines”). In those documentation guidelines, general operational processes were set forth regarding the creation and retention of medical records. This was a consequence of the overall goal of the guidelines which was to establish and guarantee consistent levels of medical care for all medical evaluation and management (E/M) services. These E/M services are those typically performed by doctors, physician's assistants and nurse practitioners in the ordinary course of providing medical treatment to patients. The defined levels of care, in turn, were intended to permit the classification and tracking of the severity level of the medical services performed, and ultimately, classification and tracking of the overall health status and medical management procedures for the patient. These Guidelines were all put in place in order to provide the best patient care at the most efficient cost. With respect to cost, the documentation guidelines also act as a gauge tied to the attending physician's compensation depending on the level of care delivered and the resultant medical progress of the patient. In the 1995 Guidelines, one conceptual data set, including twelve human body organ systems, was specified for data collection and retention. These twelve human body organ systems were the specific systems in which medical procedures could be performed and in which medical documentation would be used to define the level of care rendered by the attending physician.

The AMA's Editorial Board for Current Procedural Terminology (CPT) released another version of these documentation procedures entitled the “1997 Documentation Guidelines for Evaluation and Management Services” (hereinafter “1997 Guidelines”) in which additional organ system were defined and accommodated. A complete copy of those Guidelines is included in this application as Appendix A. Also, the 1997 Guidelines reorganized certain organ systems and created sub-portions of others which were spun out for separate documentation depending on the specialty of the attending physician. However, unlike the 1995 Guidelines, the 1997 Guidelines explicitly set forth specific medical examination elements with respect to each of the body organ systems. The level of care rendered by the physician, and the physician's resultant compensation, is determined by the number of examination elements that the physician performs during an office visit. To receive payment, physicians have to properly code each visit and display and complete the documentation for a certain number of examination elements within each organ system subset. To accomplish this, the 1997 Guidelines require a patient's disease history and progress to be tracked and recorded by entering data records into the database and specifically within the specific body organ system data subsets. That data records entry process is then made particular to the specific, recited procedures such that the level of care rendered by the attending physician and associated data entry was required to be documented within each of the specified organ systems examined, down to the level of the procedures performed. Therefore, the ultimate tracking of the patient's general heath and/or disease progress would be determined through the documentation of the patient's history and treatment plans, in combination with the specific medical procedures executed and documented by the attending physician for each and every one of the patient's organ system examined by the physician and each and every procedure performed. Both of above-recited standards, the “1995 Documentation Guidelines for Evaluation and Management Services” and the “1997 Documentation Guidelines for Evaluation and Management Services,” are incorporated herein by reference in their entirety.

The above-referenced documentation guidelines were originally introduced to facilitate and efficiently categorize the reporting of medical findings. As a consequence of their specification of specific organ systems and the specific procedures performed within each, EHR systems were designed to accommodate the Guidelines. Consequently, display fields for data entry within EHR systems are often organized to mimic the required data entry and respective groupings ascribed to the human body organ systems and procedures specified by the Guidelines. In this manner, the data provided by each physician's independent data entry occurs within computer display data fields that correlate with the desired guidelines data. I.e. all the physician's data entry regarding musculoskeletal system is entered into a computer display area designated as such, including all associated procedure data. This results in the creation of an overall medical records database in which electronic data records are input within one of the appropriate body organ data sets by the physician for each patient, with the data being available to all attending physicians. Therefore, on a per patient basis, one set of full examination data would be generated for that patient as part of the overall documentation process and would reflected the sum of the data input for each of the body organ systems of that patient as entered by the sum of all attending physicians.

Complications arise, or alternatively patient examination improvements may be realized, in situations in which the data set for a body organ system contains data from different physicians. For example, a general physician who examines the overall health of a patient, might routinely perform and document only higher level procedures within a certain set of body organ systems, e.g. a general physician only examine several single organ systems and only records select data within those systems. Subsequently, physician specialists might perform more detailed procedures and document their care within only one single body organ system and within a correspondingly more detailed diagnosis and input of standard EHR data records for that subsystem. Thus, any one patient's overall EHR data set would be somewhat random with respect to the inputs provided by physicians depending on their particular conditions and ailments. To further complicate the matter, the body organ system data actually documented, used and displayed within any given specialty practice, or even within any given doctor's office, often contains (displays) only a small subset of the total number of fields reflecting the entire set of body organ systems and procedures as defined in the 1997 Guidelines. This fractured creation and management of EHR data input into the form fields for each of these highly specific body organ system data sets creates the very problem solved by the present invention: how to display that data in a useful and efficient manner in a multitude of medical contexts?

Other data display complications exist in presenting EHR data. Aside from the different organ systems and EHR data entered into form fields. Data for a given patient is frequently entered at different time, for example, during different visitations. Computer displays are limited in their display of one particular patient encounter, not to mention multiple encounters over time. Known as temporal data separation, this is another source of computer display congestion that complicates a physician's review of patient records. In the United States, patients with chronic diseases comprise the majority of physician-patient encounters and correspondingly result in the greatest proportion of money spent on treatment. In order to make efficient management decisions when treating these patients, it is necessary for the physician to have a useful presentation of both the present medical findings as well as the patient's past data, including disease treatments. In an EHR system, this is typically accomplished by documenting present medical findings and then reviewing all available prior medical findings before deciding on a present course of treatment. Since the present EHR systems typically only show present findings and the presently treated body organ system in a dominant EHR display, the physician is forced to scroll back-and-forth through past records to review the patient's overall findings—much as with the historical paper records. Once computerized, this method of data management is time consuming, inefficient and requires the attending medical personnel to adjust repetitively and continuously his focus on multiple EHR entries while examining a patient.

Spatial data separation is the distribution of EHR data between different screens, for example different screens of single organ data—one per screen. Spatial data separation complicates the review of the patient record in the same manner as temporal data separation. As such, attending physicians are often required to toggle between different displays pertaining to different body organ system attended to by other specialty physicians, including possibly body organ systems outside those used or displayed in the doctor's usual practice. This is both time consuming and complicated in that the doctor does not typically have a plurality of screens on which to view numerous records of interest. Furthermore, all the present and past patient encounter findings are most efficiently reviewed if they are displayed within in the same set of data fields, i.e. in the same format and display layout, preferably one that the doctor is used to seeing on the screen. An attending cardiologist may not typically display dermatological data in the EHR display used within his office, but he may want to see such data as being relevant if a patient's previous skin diagnosis is a chronic condition that is relevant to other cardiovascular problems. The fixed EHR displays currently used in medical practitioner's offices pose a problem in this regard, i.e. the cardiologist would have to scroll outside the display of cardiovascular data that is normally displayed to view the dermatological data. Further, the dermatological data may be presented in a format or logical display location that is non-familiar to the cardiologist. To solve that problem on the dermatologist's end, the dermatologist, would have to scroll to the cardiovascular display to actually input findings that he may think the cardiologist would find relevant. In sum, the efficiency of the physician's review is diminished where findings relevant to similar organ systems are recorded in different standard medical data record subsets and are consequently displayed in different computer screen areas pertaining to the associated body organ system. In this manner, spatial separation of data requires the physician to scroll back-and-forth both between specialty records.

The prior art to date is lacking in the development of a truly homogeneous and universally useful display system for electronic health records (EHR). Presently, there are no universal, adaptable display systems that permit the efficient review of a patent's EHR data. Under the relatively new Guidelines, EHR data has supersets and subsets of relevant data depending on the particular patient and attending medical personnel, and all EHR data is separated both spatially and temporally. This poses a large problem within the context of the limited medical display areas provided on computer screens in the modern, medical environment. The need exists for a more uniform, method and apparatus for presenting all of a patient's relevant data, both temporally and spatially, and within appropriately selected subsets of the entire EHR data set. Further, the capability of expanding a particular set of displayed data records within a given standard display is a desirable intermediate result that would greatly aid the physician's review.

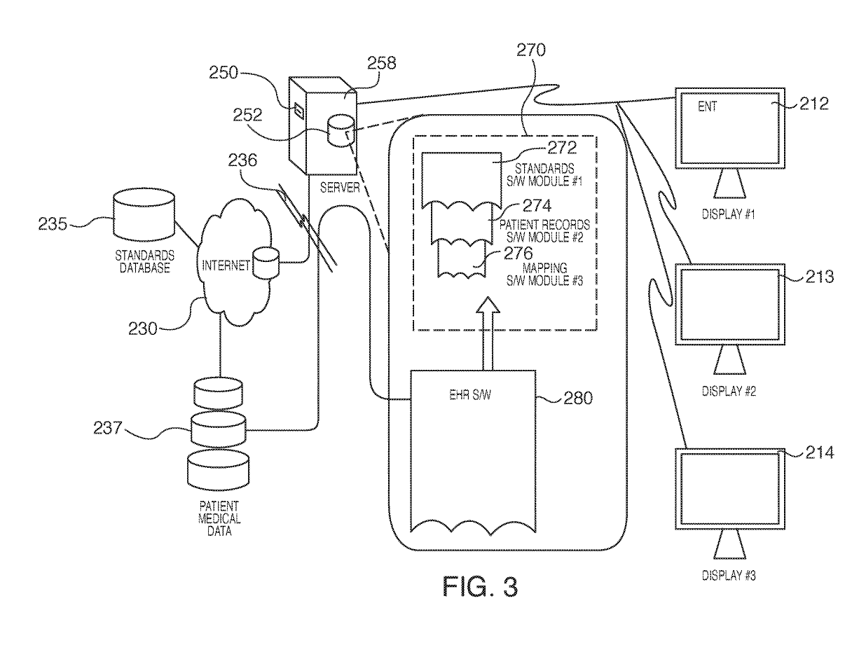

Referring to FIG. 3 a combined hardware-software diagram is presented illustrating an exemplary software plugin module according to one embodiment of the invention. Computer server 258 contains a processor 250 and associated memory 252 coupled to the processor. Processor 250 and server 258 is coupled to one or more displays 212-214 and controls the information presented thereon. Associated memory 252, which may constitute one or more discrete sub-memories, stores a display program, 270 containing a plurality of programming modules 272-276. At a minimum the display program includes a standards software module 272, a patient records module 274 and a mapping module 276.

Server 258 may also be configured to run dedicated EHR software 280. Display software 270 may be a part of the EHR software (i.e. compiled as one with it) or it may be a stand-alone application or separately running piece of software. Further, the EHR software may be distributed such that only a portion of the software resides and operates on the server.

The server 258, display program 270, and EHR software 280 are all associated as a unit and serve to function on one side of logical network demarcation 236. Logical network demarcation 236 may be the router 36 of FIG. 1 or any other logical network breakpoint. Standards database 253 and patent EHR data bases 237 are disposed on the other side of the logical network breakpoint and area coupled by the various network and internet connections provided on FIG. 1. Patient EHR database 237 may be located in the commercial cloud storage media 39 or in any of the local or proprietary databases 37, 38, 39.

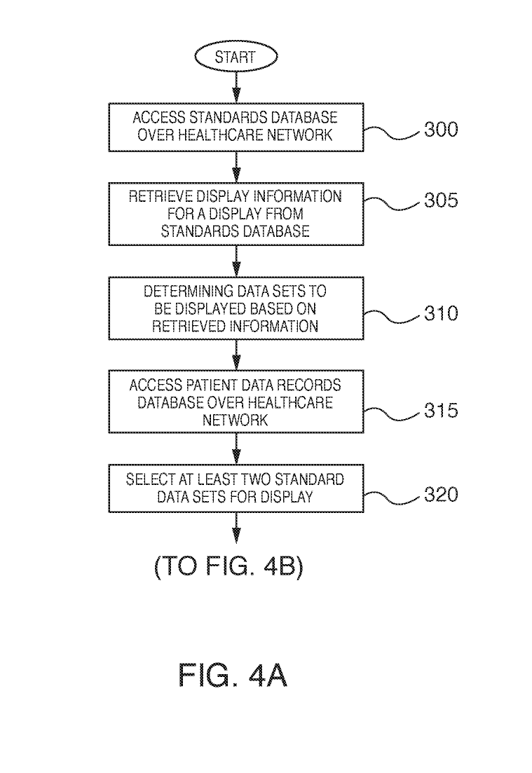

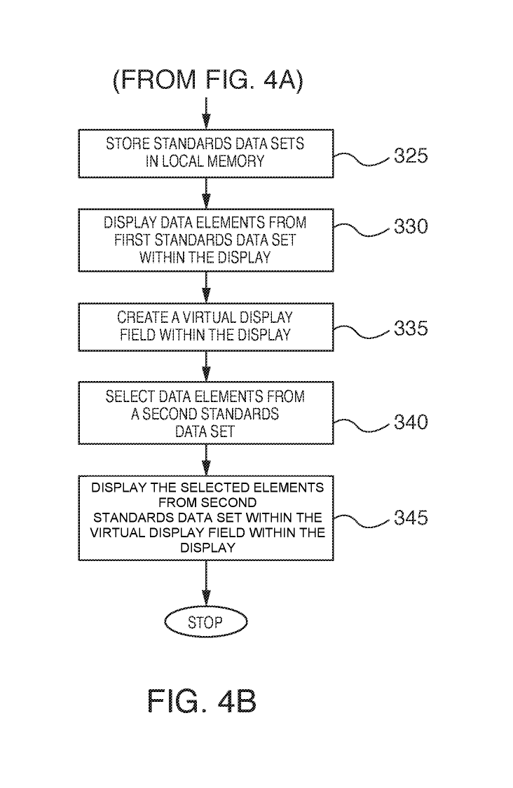

FIGS. 4A&4B show a method of operation of the present invention according to one preferred embodiment. Referring to FIG. 4A, a standards database is first accessed over the health care network by one of program modules comprising the display program. Step 301. That software module then retrieves display information from the standards database. Step 305. The display information can include anything regarding the display of a set of standard data including but not limited to the position and labeling of the display fields for displaying the data elements within the set of standard data. The software module then determines a first and second set of data to be displayed within at least a first display. It should be noted that the actual data to be displayed may not yet be retrieved but the software module needs to preformat, i.e. size and set, the display in some sense in anticipation of the actual display of data. The same, or another software module within the display program accesses a patient records database over the health care network. Step 315. That software module then selects a first and second set of standard data to be displayed in computer-based display. Step 320.

Referring now to FIG. 4B, after selecting the data sets the software module stores the data elements from the two data sets within a local memory coupled to the display. Step 325. The same or another software module within the display software displays the data elements of the first set of standard data within the display field of the display according to the retrieved display information. Step 330. That software module then creates a virtual display field within the display for displaying other data elements that are not part of the first set of standard data. Step 340. The software module then selects data elements from the second set of standard data elements for display within the virtual field. Step 340. Finally, the software module displays the selected data elements from the second set of standard data within the virtual filed within the display. Step 345.

It should be appreciated that the software modules of the present invention are customized to display data according to the needs of each type of medical practice and possibly also to individual physicians' specific requirements. The objective of the software modules is to display Electronic Health Records (EHRs) in a meaningful fashion within the clinical setting. Although three such display software modules have been recited here other display software module may be included such as: communication modules (for communicating with other portions of the EHR software and computer systems), display modules (for conditioning, formatting, typesetting rendering the display), power modules (for powering various portions of the display); and data translation modules (for translating, reformatting, converting transforming and otherwise manipulating the display data in any format possible).

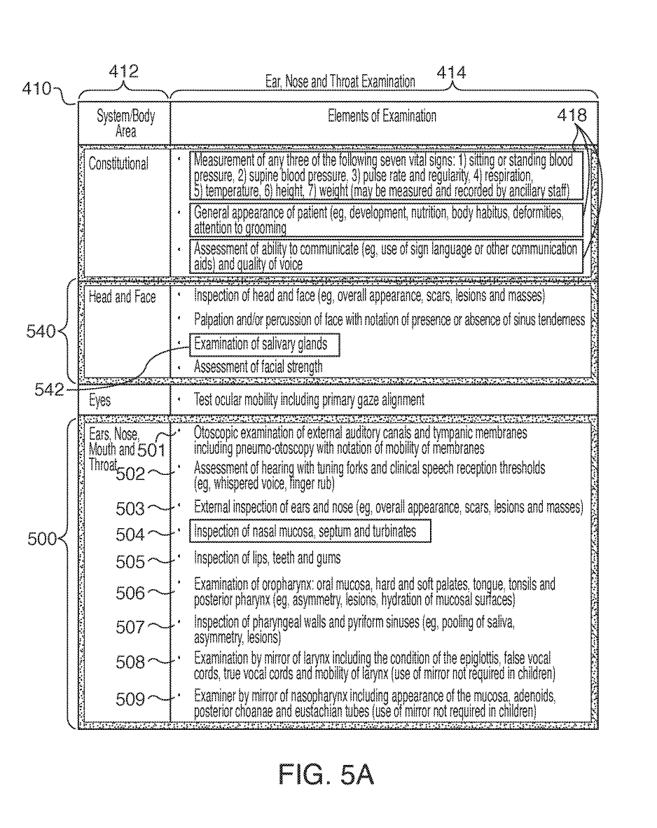

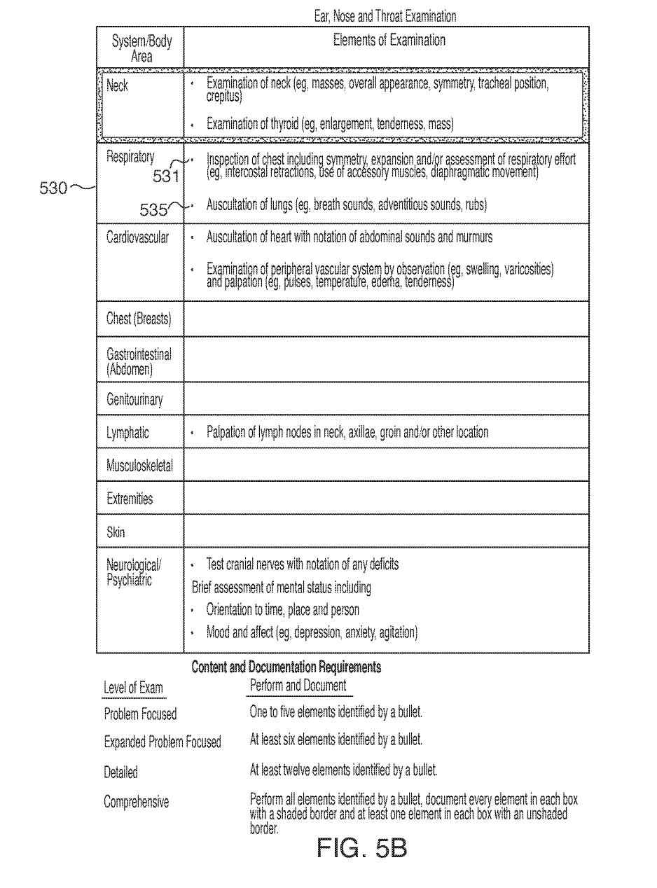

The actual practical application of the disclosed system, apparatus and methods are provided in FIGS. 5-9. This invention provides a system and method wherein shared patent data records are centrally stored as EHRs. The data constituting the EHR data is input by physicians into display data filed within a computer display where the form fields provide for the display of one entire set of standard data per display screen. In one particularly preferred embodiment, the display fields and the entered standard set of data are in one-to-one relation and correspond to a standard set of body system data or organ system data as provided in the 1997 E/M services guidelines for CPT data. Data entry fields within a computer display may be displayed in their entirety (i.e. corresponding to the entire set of standard data) or may display any subset thereof. Further, new data recorded in any of a plurality of such standard data fields may also be displayed therein. This is accomplished by defining a display architecture in which data entered in each and every data field of the entirety of the standard data field set is programmed with the capability of being mapped to and displayed in a specified data field of every subset of the standards data field display, including those displays in which certain data fields are not required or typically viewed. In many cases this will result in the mapping of a display fields from a first display, in which data is entered into multiple data fields in the display, into a second display containing a fewer number of data fields. Database display integrity requires that any data entered into a particular display data field should be shown within that corresponding data field, if present. When not present, the data entered into a particular data field may be mapped onto, within, aside or near another data display field. Typically, the data being mapped holds a close relationship to the data display field to which or near which it is mapped. In the most extreme case of consolidation and mapping, content typically displayed in multiple display fields may be pooled in content and mapped to a single, virtual display field. This, in essence, acts as a replacement of the original data display field(s), i.e. where the original display field is that which would be displayed in the absence of mapped data from other fields.

In one particular embodiment, the present invention includes virtual fields within or near the data display fields in which either a single datum is displayed in that field or the contents of multiple other data fields are combined within one display field, possibly along with that display field's native and originally intended data. Proximity of related data in the eventual resulting display is desirable. It should be noted that throughout the description of the invention, actual display capability should be understood to mean both actual display and capable of being displayed. More particularly, when data display fields are mapped from one display to another, the data within those field may be forced to be displayed in the indicated destination data display field—i.e. an expanded display field. Alternatively, the data may be “made available” near that data display field, for example in the form of a graphical “drop down box.” The present invention further expands the remapping concept by providing a display architecture of reciprocal virtual fields that enables users to display and enter data into standard data field subsets of the total displayable data fields within the entire database. The full data record set is available and capable of being displayed to every other authorized user even if such other authorized user selects a different standard display data field set for his or her own display and entry. In particular, any authorized user may display complete records in any of the plurality of standard data field sets chosen as most appropriate for the present data review purposes regardless of which data field set or which plurality of data field sets were used to record the data to be reviewed.

The invention will be described and its principles demonstrated as applied in an EHR system and specifically in the display and data entry portion of the EHR system used for the recordation and documentation of the findings of the attending physician. The display, recordation and storage of this information within the EHR are for the purpose of medical evaluation and management a patient. The invention will further be illustrated in the context of the plurality of body organ systems and corresponding medical procedures provided in the 1997 Guidelines.

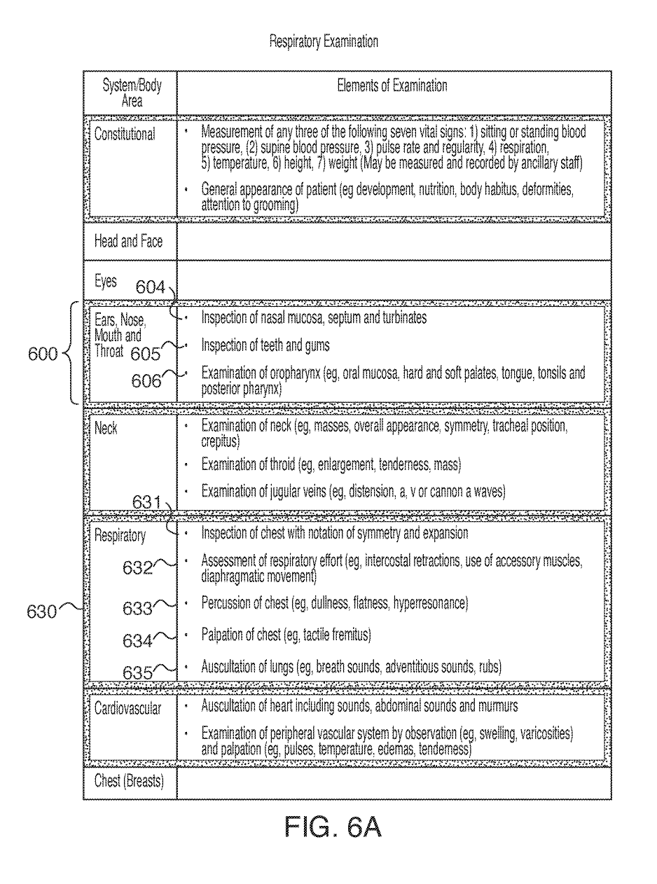

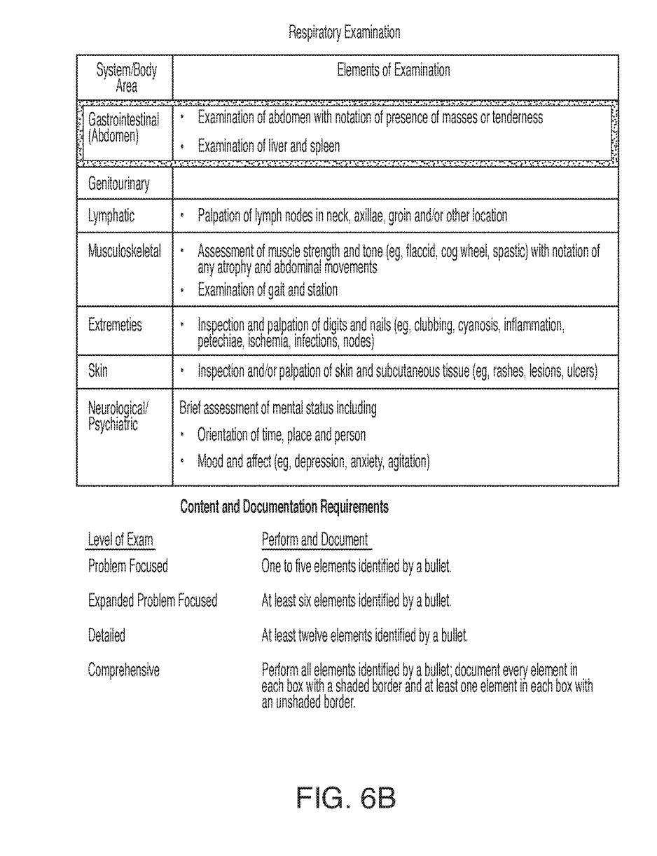

FIGS. 5A&B and FIGS. 6A-6B show computer displays in which the CPT-defined standard data sets are displayed within respective data fields. FIGS. 5 and 6 A&B show the display of the standard data fields for the examination of the ear-nose-throat (ENT) system and respiratory organ system respectively. Ideally and for the efficient retrieval of all data, the treating physician should be able to display and review the complete content of past records recorded in either of these data display sets, or for that matter any of the other standard data field sets. If in the middle of his encounter, a physician decides that switching from one to another standard data field set will qualify his current encounter for a higher level of payment because it permits a higher-level visit according to the criteria associated with other standard data display set, that physician should still have access to the full content of all past encounters for the same patient, content that is now displayed in the second standard set of data fields. Thus, it is one objective of the invention to realize the concept that any medical professional should have access to the preferred standard screen displays and data associated with other medical professionals, despite the fact that a given professional may have one particular area of practice expertise. I.e. in the most general case, any attending physician has access to each and every one of the “standard” set of CPT display data fields, including historical data entered into any of those displays data fields.

It should be appreciated that the CPT Guidelines specify only the procedures that are to be included within the defined body organ systems. The CPT Guidelines do not necessarily specify anything regarding the actual display data fields including their layout or presentation aspects. These have been adopted in varied and numerous formats by companies that make EHR system software. Thus the description below is illustrated with reference to only the generalized body organ fields as displayed and presented in the 1997 Guidelines as if that were the actual, fully-defined, computer display itself. Individual physician's displays that conform to the 1997 Guidelines will invariably have a radically different look-and-feel from those provided herein, although the data contained within the respective fields is likely to be consistent with and compliant with the general precepts of the Guidelines.

Most specialist physicians will record their patient E/M encounters in the single, standard, formatted display data field set that most closely accommodates the needs of their area of medical practice. In order to track a patient's condition over time, however, that physician may want to display data records entered by other physicians in different standard display formats together with his or her own. Thus, a cardiologist may tend to exclusively use the standard cardiovascular examination display data set while a dermatologist may tend to use the standard display data set for examination of the skin. However, the dermatologist may also want to read the cardiologist's description of a rash that was either active when the patient was in the cardiologist's office or that developed as a result of the cardiologist's examination (e.g. under the electrode adhesives when the cardiology nurse recorded an electrocardiogram). In other aspects, a generalist might want to use different standard display data sets to record findings for the same patient if he appears on one occasion for evaluation of chest pain and on another occasion for treatment of a rash. However, the dermatologist may also want to read the cardiologist's description of a rash to determine its cause. The dermatologist would understandably be interested in a rash that was active when the patient was in the cardiologist's office, or if it developed as a result of the cardiologist's examination. For example, the dermatologist would want to distinguish whether the area of the skin under the electrode adhesives was affected when the cardiology nurse recorded an electrocardiogram or if the reaction it was an allergic reaction to one of the cardiologist's prescriptions. The problem is that prior to the present invention there was no efficient way that different physicians or even the same physician recording findings in different standard data sets at different times could display the complete data content of all of a patient's past evaluation and management encounters as recorded in the respective and different fields of different standard display data fields corresponding to associated EHR system's medical data records.

Consider a patient examined by two different doctors: an ear nose throat specialist (ENT) for chronic sinusitis and a respiratory disease specialist for asthma. FIGS. 5A-5B show a “mock” display representing a typical EHR system display that the examining ENT may be viewing while examining the patient and recording examination data. Since all the information specified by the Guidelines, or information that might otherwise be important, may not fit on one display screen, the sequential figures, FIG. 5A and FIG. 5B represent two independent but contiguous screens of information. FIGS. 5A and 5B show a “mock” electronic display 410 having two columns indexing the organ system/body area 412 against the elements of examination 414. As shown, the System/Body Areas are those specifically set forth by the 1997 Guidelines for an ENT patient visit. Contents of each cell of the examination element column 414 include each and every procedure for which the 1997 Guidelines provide a valuation and against which the attending physician's level of care is evaluated. The display is a “mock” display because the system/body areas in column 412 and the elements of examination are taken straight from the 1997 Guidelines and replicated, in exactly the same order, as specified by the Guidelines. This will not be the case in a customized display. The examination elements in column 414 provide each and every measurement or test that the examining physician can conduct and for which a valuation pertaining to the level of care is ascribed by the Guidelines. Therefore, each of the areas 418 behind the bullet points represent actual data entry fields within the EHR system display and into which the doctor is expected to enter data for that particular examination element, once they are performed. The overall content and documentation completion requirements and guidelines are provided at the bottom of in FIG. 1B.

Regarding display layout, the ear nose and throat specialist would most likely record his examination findings using the standard display data fields of the ear nose and throat specialist (system/body area, element 500) as specified by the 1997 Guidelines. As the ENT performs each of the examination elements within that section, he or she would record the patient findings in the relevant data entry area corresponding to the examination element performed. Once the nasal mucosa, septum and turbinates are examined, the doctor enters his findings into display field 504. After performing the desired examinations within the ENT section and recording the findings, the ENT may then wish to wander to other areas of the overall display record and examine the salivary glands 542 in the head and face section 540. Data would likewise be entered into the display data field 542 after examination. The doctor would then traverse the examination elements as needed and perform the same to arrive at a patient diagnosis or status.

Again, FIGS. 5A-5B provide a “mock” medical office display in that it replicates exactly the 1997 ENT Guidelines and elements of examination broken down in the exact body organ system/body areas specified by those Guidelines. Any particular ENT office EHR system and display may be organized differently such that the arrangement of the display is drastically different. The health care insurers, regulators, and data coordinators are likely to continue to force adherence to the actual set of standard data for each body or organ system.

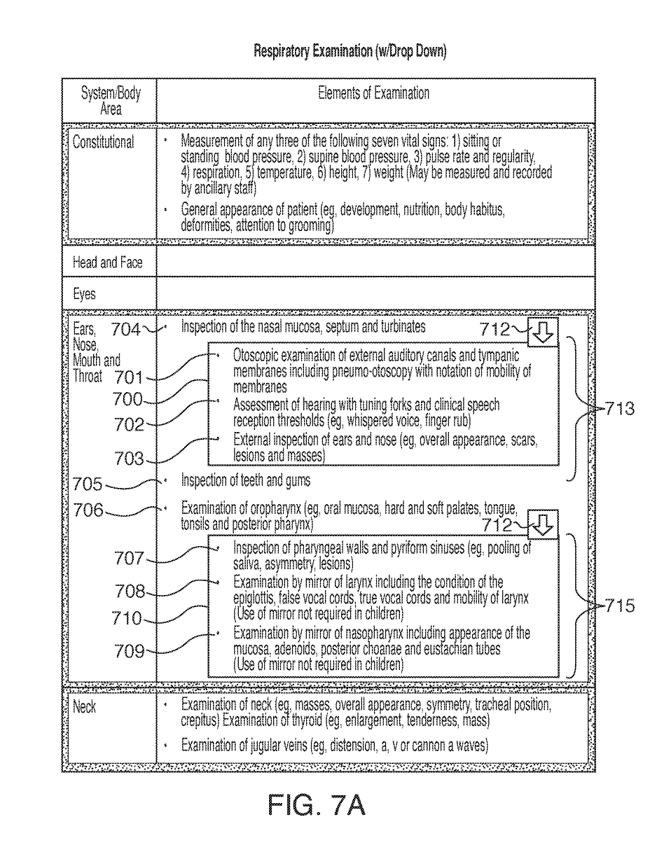

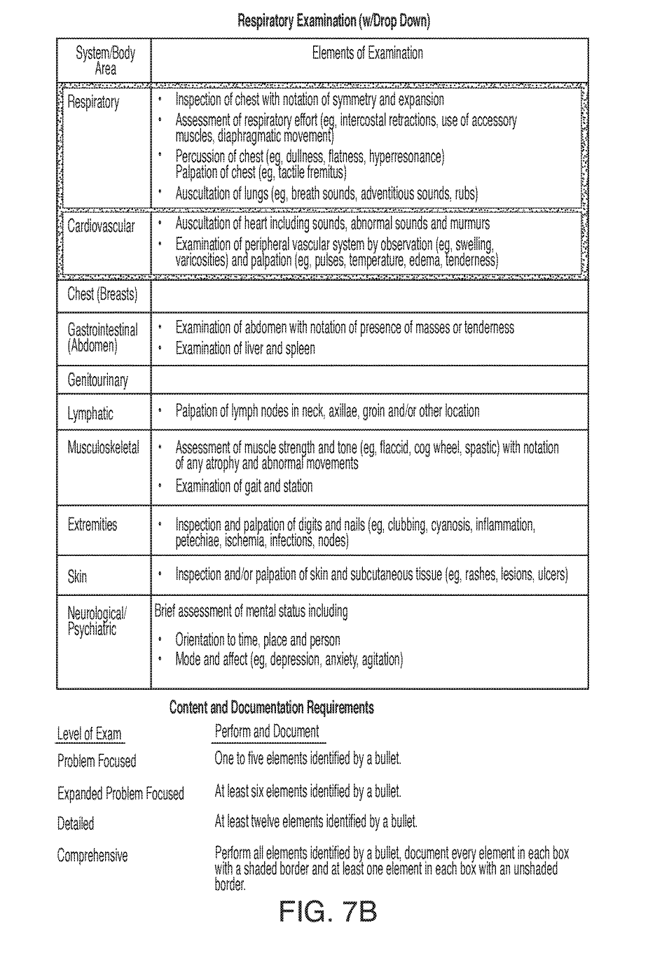

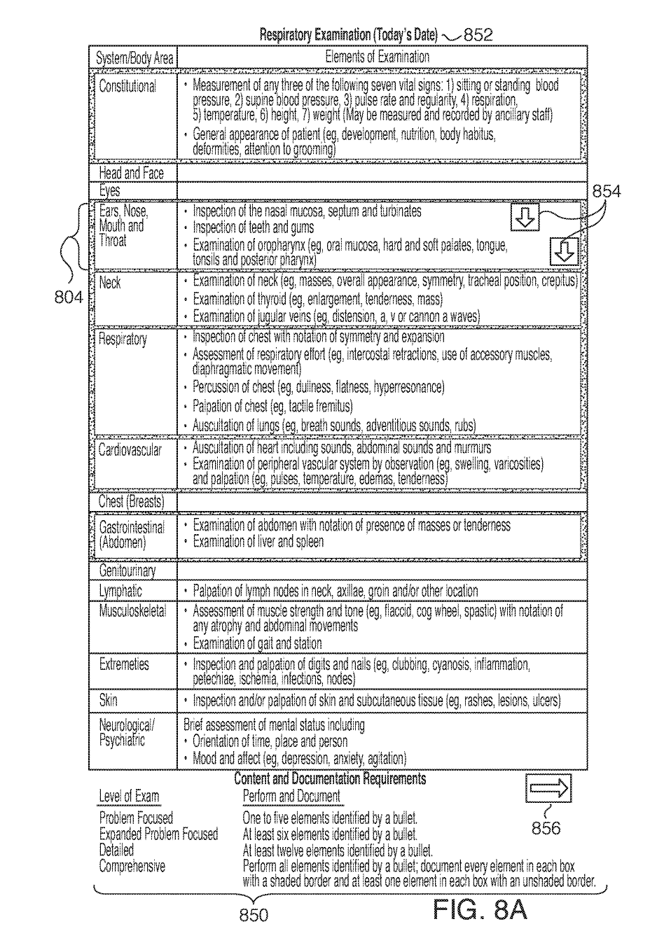

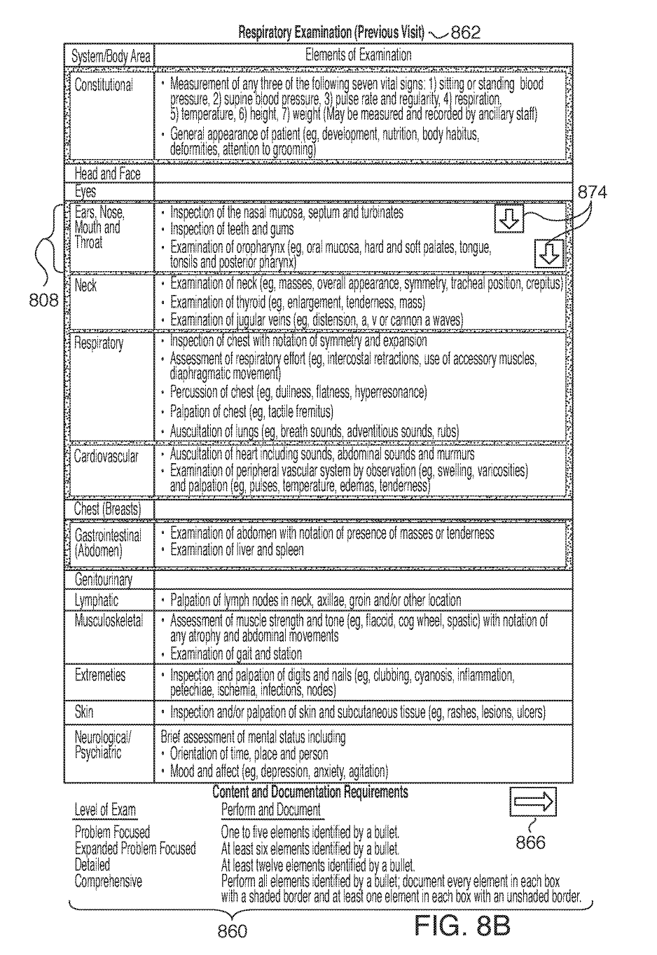

Upon examination by the second doctor, the pulmonologist, FIGS. 6A-6B illustrate where the respiratory disease specialist records his findings using the standard respiratory examination data set 630. According to the CPT display criteria for an ENT, the section of the physical examination display used to enter and display documented findings in examining the ears, nose and throat 500 of FIG. 5A, the ENT is provided nine separate data display elements with which to work and enter data, 501-509. In the corresponding ENT section of the CPT used by respiratory specialists 600 of FIG. 6A, the ENT section of the physical examination display used to enter and display documented findings in examining the ears, nose and throat of the respiratory organ system, the pulmonologist has only has only three separate display and entry elements 604, 605 and 606. Complementary-wise, the CPT display section provided to the pulmonologist to display and enter respiratory data as part of the pulmonologist's exam 630 allows for five separate data elements 631-635. The CPT used by the ENT for displaying and recording respiratory data 530, provides for only two corresponding data elements 531 and 535. If these two physicians store and retrieve their electronic health records to and from the same database and have access to each other's records, reciprocal, virtual mapping within each physician's preferred display allows each physician to view his own complete findings and also those of the other attending physicians. This is particularly true, if the physicians choose to use displays that are customized. Possibly not so much so if the CPT also promulgates the actual display that is required to be used by the physician. In either case, and as shown in FIGS. 7-8, the apparatus and methods of the present invention provide for virtual field mapping so that additional data may be displayed within a form field that is otherwise not present. As a result, each physician has a more complete set of data on which to base any clinical decisions.

As an example of this and according to one preferred embodiment, FIG. 7A illustrates the display that results when the respiratory disease specialist pulls up the data regarding the ear nose and throat specialist's encounter in his preferred (respiratory) display format. In this case, the content of the ENT's ear nose and throat data fields #501, 502, 503 and 504 are mapped to an expanded virtual display field 713 by the display program and in the position of respiratory organ system examination ear nose and throat field #1, 604. This is a virtual field because the original display area has been expanded and the actual data it displays resides in four separate data fields of the electronic health record database, although it is displayed within one data display field as defined by the standard. That is to say, the “typical standard data defined by the standard and formerly displayed within a single display field has now been expanded to include other standard data from other EHR data records—all to be displayed within the same one display field. The data, previously available to the respiratory physician is now expanded to include other physician's data as entered by them in their standard data fields and included within their sets of standard data. The mapping of that data into a virtual field is one way to display it in the respiratory physician's familiar data display format. In alternative display embodiments, the supplemental display data may be simply concatenated and presented in one string within the existing field. In other presentation embodiments, drop down boxes 712 may be presented that indicate that additional data is available. In alternate embodiments of the invention, this data may be either always be displayed or optionally be displayed when prompted to do so by the physician. In additional embodiments, per the above discussion of the display of historical data, this field may also be retroactively mapped to include all past data in any given field according to any of the numerous CPT compliant displays.

The content of the ENT physician's display field 605 within the ENT standard display, in this case “inspection of lips, teeth and gums” of FIG. 5A, will display directly in the ENT display portion, field #2 or 705 of FIG. 3A, of the standard respiratory organ system data display set. This is not a virtual field as it is a direct display in one field of the content of one field of the total database. The content of the ENT physician's display field's #6-9, or 506-509 of FIG. 5A, will display in a single virtual field 715 in place of the usual third ENT data display field, 706, of the respiratory organ system data set. Again, the supplemental data may be presented in any of a plurality of formats, including but not limited to concatenation of all the data for immediate non-optional presentation, or through the use of other indicators that point to additional data being available.

When the respiratory specialist pulls up the record of his own previous examination he will not see virtual fields but the exact content of his own previous data entries in each of his three ENT data fields. These are real fields and not virtual fields because the data displayed in each is the data residing in a single real field of the electronic health record database.

What happens when the ear nose and throat specialist pulls up records for the same two past encounters in his own preferred data display format (the field set of the ear nose and throat organ system examination)? The ENT sees the real data he entered in each of his nine ENT fields from his own past encounter records. When the ENT pulls up the encounter record of the respiratory specialist, the content of the respiratory specialist's ENT field #1 is shown in his own ENT field #4, that of the respiratory specialist's ENT field #2 in his own ENT field #5 and that of the respiratory specialist's ENT field #3 in his own ENT field #6. These are real fields rather than virtual fields because each is also the content of one real field of the total electronic health record database.

There is reciprocal virtual field mapping when these two physicians review each other's findings of the patient's respiratory system, for which the ENT data set has two elements while the respiratory organ system data set has five. When the ENT specialist pulls up the respiratory specialist's encounter record, the first of his two respiratory data fields will display a virtual field with the content of the respiratory organ system examination's respiratory data fields #1, #2 and #4. The second of the ENT physician's two respiratory data fields will display a virtual field with the content of respiratory organ system respiratory data fields #3 and #5. When the respiratory specialist pull up the ENT specialist's findings for the respiratory system in his own data display format, the real content of ENT respiratory data field #1 will display in the respiratory organ system data set's respiratory data field #1 and that of ENT respiratory data field #2 in respiratory organ system examination respiratory data field #5. These data mapping and grouping functions are not automatic; they are deliberately assigned based on the best clinical fit and those presented here are simply illustrative of the way the technology of reciprocal virtual fields mapping works.

The outcome is that while no user of the EHR uses a data display that contains the full set of data fields, every user can enter data in the most appropriate of the standard fields for either his specialty or for that clinical circumstance, and every user with access to records entered using other standard data sets can display the complete content of those records in whichever of the standard data display and entry formats is most appropriate to his use on that occasion.

Some customization of the standard data display sets is possible within the constraints of the field mapping architecture. Customizations that would be compatible with the field mapping architecture would generally consist of adding fields to one's own version of one of the standard data field sets that already exist in one of the other standard data field sets.

FIG. 8 illustrates a computer display in which two columns of data are displayed within a single display—side-by-side. In the example of FIG. 8 the data displayed is that provided to the pulmonologist. The data entry fields are substantially similar to those found in FIGS. 6A-6B and include similar data entry fields. The left-hand column of data display 850 is provided for the physician to input data pertaining to the present visit. The date of the present visit is shown at the top 852. The right hand column 860 shows data pertaining to a previous visit to the pulmonologist, the date of which is identified at 862. Drop down boxes 854 and 874 are also provided in the manner described above to reveal additional information within the data entry fields 804 and 808 respectively. User selectable scrolling arrows 856 and 866 are provided so that the individual column displays may be changed to view data provided at different dates or even to scroll to different data columns entirely such as those provided to an ENT or a cardiologist. In this manner, the attending physician may view the patient's data in any fashion necessary to accommodate his or her informational needs.

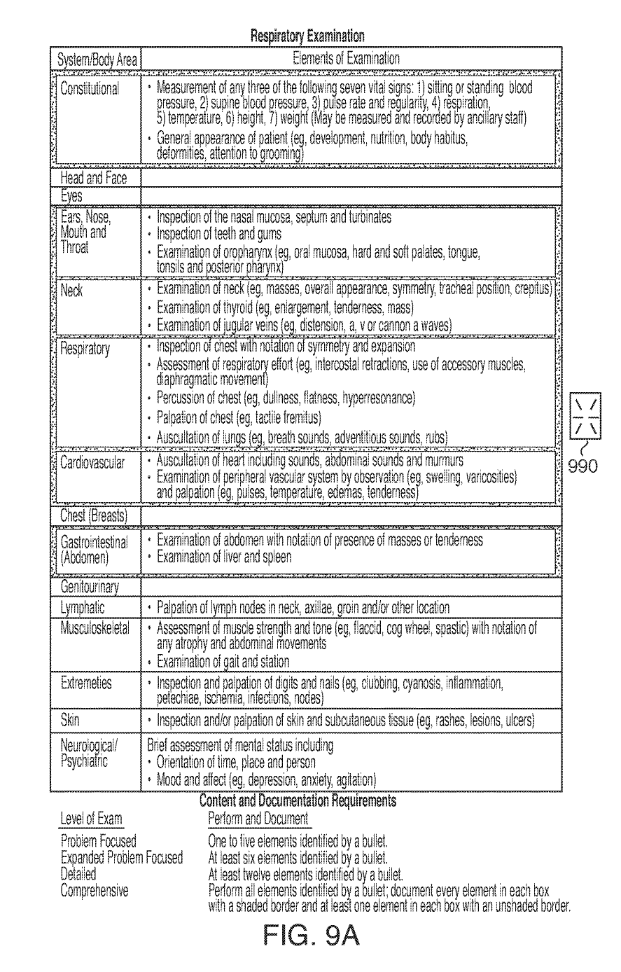

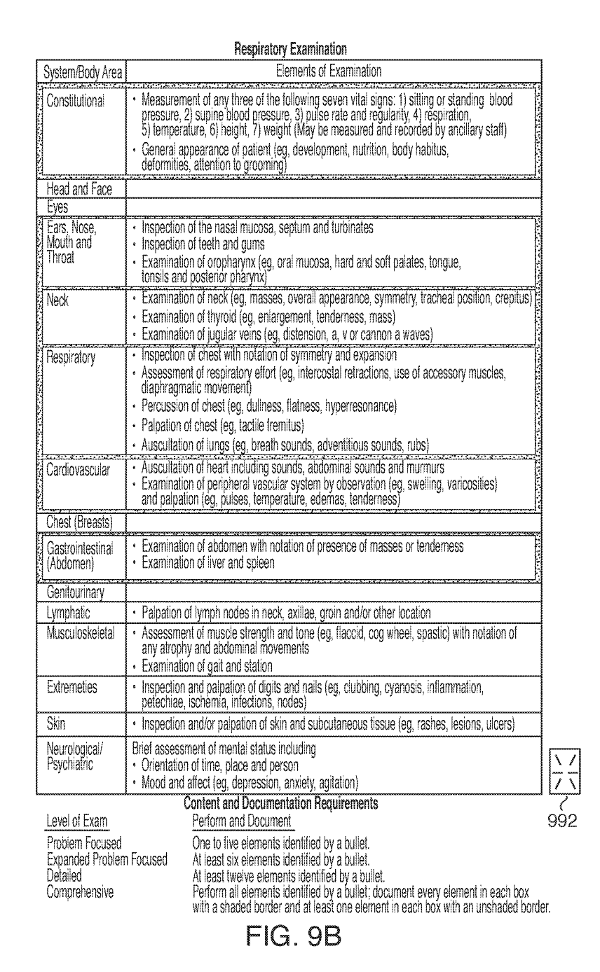

FIGS. 9A and 9B show the same two columns of FIG. 8 with alert boxes 990 and 992 shown. The alert boxes act as a flag to indicate that a critical data is present within the virtual display field. Health care providers can indicate such critical data when inputting the same on their own display and within their own standard set of data so as to indicate to other attending health care personnel that the condition exists. Thus, if the standard data set and corresponding display of the next attending physician do not include those data fields as standard for their practice area, the present invention they can “forcibly” present them within the display to indicate that the critical condition exists. For example, the patient records module can be programmed to retrieve all critically flagged data entered into any set of standard data by any physician. The mapping module can then be programmed to “forcibly display” that data with a “flagged” virtual display field within the attending physician's display so that it is immediately apparent to the attending physician. In this way, the display of standard sets of data for a given patient within a given medical context does not compromise the patient's overall care because the attending physician does not typically deal the medical area involving the critical malady. Rather the present invention can enhance that patient's care by bringing special attention to those critical data and forcibly displaying them to all attending physicians. The alert boxes may be used to indicate that a patient has a chronic, an abnormal or an acute, condition recorded within that patient's history of data entry. By simply “clicking” on the alert box using a graphical user interface, the attending physician may display the data entered in connection with that condition. A peanut or latex allergy identified by an allergist is a quintessential example of a patient medical condition that is worth of universal broadcast to all attending physicians

It should be appreciated that the alert boxes may be place anywhere within the display and even with the actual data fields of the columnar displayed data.

### General Computer-Based Systems, Networks, Devices Structures and Processes

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

### General Nomenclature:

The terms “a” or “an,” as used herein, are defined as one or more than one. The term “another,” as used herein, is defined as at least a second or more.

The terms “including” and/or “having”, as used herein, are defined as comprising (i.e., open transition).

The term “coupled” or “operatively coupled,” as used herein, is defined as connected, although not necessarily directly and mechanically.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

The invention claimed is:

1. A computer-based electronic health records system including a display processor coupled to an associated memory, said display processor coupled to a computer display for displaying a patient's electronic health records, said display processor coupled to a computer-based health care network and running a display program from said associated memory, said display program comprising:
a standards module, said standards module accessing a standards database over said health care network, said standards module retrieving from said standards database information regarding a first and second display, said standards module determining a first and second set of data to be displayed within said first and second displays respectively on said computer display based on said retrieved information;
a patient records module, said patient records module accessing a patient records data base over said health care network, said patient records module selecting a first set of standard data to be displayed in said first display, said patient records module selecting a second set of standard data to be displayed in said second display, said patient records module retrieving said first and second sets of standard data and storing said first and second sets of standard data in said associated memory, said first and second displays having data fields in which data elements of said respective first and second standard sets of data are displayed; and
a mapping module, said mapping module displaying said data elements of said first standard set of standard data within said data fields of said first display, said mapping module creating at least one virtual display field within said first display, said mapping module selecting data elements from said second set of standard data to be displayed within said first display, said mapping module displaying said selected set of second data elements within said virtual fields for composite display with said data elements of said first set of standard data.

2. The system of claim 1 wherein said first and second displays are themselves standard and said data fields of said first standard display correlate with said data elements within said first set of standard data, said display program displaying each data element of said first set of standard data within said corresponding data field of said first standard display.

3. The system of claim 1 wherein said virtual display fields within said first standard display are customized and specified by a health care professional, said health care professional specifying said set selected set of second data elements to be displayed within said virtual field.

4. The system of claim 1 wherein said virtual field is one of an expanded field or a drop-down box.

5. The system of claim 1 wherein said virtual field further includes an alert box, said alert box indicating a critical condition within said selected set of second data elements within said virtual field.

6. The system of claim 1 wherein said first and second sets of standard data contain EHR data of a medical patient, said EHR data pertaining to one of a body system or a single organ system of said patient.

7. The system of claim 6 said first and second displays are associated with a first and second physician practice areas respectively, said second set of data elements within said virtual field not being within said first set of standard data.

8. The system of claim 1 wherein said first and second sets of standard data contain EHR data of a medical patient, said EHR data pertaining to one of a body system or a single organ system of said patient.

9. The system of claim 7 wherein said sets of EHR data are those specified by a set of guidelines issued by a medical organization.

10. A computer-implemented method for displaying electronic health records using a computer-based health records system, said electronic health records system including a display processor coupled to an associated memory, said display processor coupled to a computer display, said display processor coupled to a computer-based health care network and running a display program from said associated memory, said display program including a standards module, a patient records module and a mapping module, said method comprising:
accessing a standards database over said health care network with said a standards module;
retrieving from said standards database with said standards module information regarding a first and second display, said standards module;
determining with said standards module a first and second set of data to be displayed within said first and second displays respectively on said computer display based on said retrieved information;
accessing a patient records data base over said health care network with said patient records module;
selecting a first and second set of standard data to be displayed in said first and second display respectively, said first and second displays having data fields in which data elements of said respective first and second standard sets of data are displayed;
storing with said patient records module said first and second sets of data in said associated memory;
displaying with said mapping module said data elements of said first standard set of data within said data fields of said first display;
creating with said mapping module at least one virtual display field within said first display;
selecting with said mapping module data elements from said second set of standard data to be displayed within said first display; and
displaying with said mapping module said selected set of second data elements within said virtual fields for composite display with said data elements of said first set of standard data.

11. The method of claim 10 further comprising displaying said virtual field as one of an expanded field or a drop-down box.

12. The method of claim 10 further comprising displaying an alert box, said alert box indicating a critical condition within said selected set of second data elements within said virtual field.

13.

14.

15.

16.

17.

18.

19.

20.
